(19) United States
(12) Patent Application Publication
(10) Pub. No.: US 2016/0295621 A1
(43) Pub. Date: Oct. 6, 2016

(54) METHOD FOR DEVICE-TO-DEVICE COMMUNICATION AND A CORRESPONDING CONTROL METHOD

(71) Applicant: ALCATEL LUCENT, Boulogne Billancourt (FR)

(72) Inventors: Feng Han, Shanghai (CN); Wu Zheng, Shanghai (CN); Kaibin Zhang, Shanghai (CN); Yan Meng, Shanghai (CN); Zheng Liu, Shanghai (CN)

(73) Assignee: ALCATEL LUCENT, Boulogne Billancourt (FR)

(21) Appl. No.: 14/442,611

(22) PCT Filed: Oct. 28, 2013
(86) PCT No.: PCT/IB2013/002558

§ 371 Date: May 13, 2015

(30) Foreign Application Priority Data
Nov. 15, 2012 (CN) 201210461485.5 15

(51) Int. Cl. H04W 76/02; H04W 36/00; H04W 56/00; H04B 7/06; H04L 1/18; H04W 36/38

(52) U.S. Cl. CPC H04W 76/023; H04L 1/1861; H04W 36/38; H04W 56/001; H04B 7/0626; H04W 36/0055

(57) ABSTRACT

The prior art does not prescribe how to divide a control plane among network elements in a D2D communication under cellular architecture. To fill the technological gap, the present invention provides a method of performing the D2D communication and a corresponding control method, wherein a protocol signaling and protocol stack function of a media access (MAC) layer are implemented in a UE performing the D2D communication, and a control function is implemented by a master UE without introducing the base station, thereby reducing complexity of the base station and avoiding delay caused by the control of the base station; and wherein a protocol signaling and protocol stack function of a radio resource management (RRC) layer are implemented in the base station and the UE, and the control function is implemented by the base station and the base station performs mobility management.

### FIELD OF THE INVENTION

The present invention relates to a radio network, and particularly to device-to-device (D2D) communication in the radio network.

### BACKGROUND OF THE INVENTION

At present, device-to-device (D2D) communication based on a cellular infrastructure draws concerns in the industry, which is capable of meeting the applications and requirements that two close devices can directly communicate with each other. One application scenario is for commercial/social use, wherein close users running social networking application can exchange their data directly without forwarding by a base station. Another application scenario of D2D communication is for the public safety in case of emergency events.

One example of D2D communication scenario is given in FIG. 1, where packets of two UEs in proximity, namely, UE1 and UE2, are directly transmitted via a direct D2D link between the two UEs. The two UEs may also establish an ordinary cellular link with the base station (eNB). Generally, both of the two UEs implement full user-plane functionality in order to achieve direct exchanging of traffic data.

However, for control-plane functionality, a definite implementing mode has not been formed yet in the industry.

Generally speaking, the control plane includes a radio resource control layer, a media access layer and a physical layer for carrying the foregoing two layers, wherein the radio resource management layer is mainly used for the function of radio connection management, e.g., controlling the hand-over of cells; the media access layer is mainly used for the function of link adaptivity, e.g., deciding a modulating and coding scheme for the radio link, or performing HARQ for transmission on the radio link. For example, in an LTE system, the radio resource control layer is the RRC layer, the media access layer is the media access control (MAC) layer, and the physical layer is the PHY layer. However, in IEEE 802.16m, the radio resource control layer is a radio resource control and management (PRCM) layer, the media access layer is the media access control (MAC) layer, and the physical layer is the PHY layer. Taking the LTE system as an example, for the ordinary cellular communication between the base station (namely, eNodeB or eNB) and the UE, the control planes of both of the base station and the UE perform the function of the RRC layer and the MAC layer respectively, wherein the control function of the RRC layer and the MAC layer is implemented at the base station. However, for D2D communication, as illustrated in FIG. 2, it involves three or even more network elements, such as two D2D UEs communicating with each other and the base station. In the industry there is not yet proposed a technical solution about how to configure the functionality of the control plane for them so as to better achieve the control.

### SUMMARY OF THE INVENTION

The prior art does not present a design on how the control plane of the D2D communication exists in the radio communication system. The technical problem to be solved by the present invention is how to configure the existing manner of the control plane in relevant network elements in the D2D communication. An inventive concept of the present invention lies in directly configuring, at the

UE performing the D2D configuration, signaling exchanging and protocol stack related to the media access layer in the D2D communication, and configuring, at a base station and the UE, signaling exchanging and protocol stack related to radio resource control. Based on the division manner of the control plane, the media access layer signaling, e.g., channel state information feedback and HARQ ACK/ACK information are directly exchanged between two UEs, and a master UE performs control without introducing a base station, thereby reducing complexity of the base station and avoiding delay caused by the control of the base station. Regarding the radio resource control signaling, e.g., measurement related to the radio resource management, is reported by the UE to the base station, and the base station performs mobility management.

According to an aspect of the present invention at the UE, there is provided a method of performing D2D communication in UEs, wherein the method comprises the following steps:

i. directly exchanging with another UE signaling of a media access layer for the D2D communication;

ii. implementing locally at the UE protocol stack function of the media access layer for the D2D communication; and steps of:

iii. directly exchanging with a base station signaling of a radio resource control layer for the D2D communication;

iv. implementing locally at the UE protocol stack function of the radio resource control layer for the D2D communication.

According to an aspect of the present invention at the base station, there is provided a method of controlling device-to-device (D2D) communication in a base station, wherein the method comprises the following steps:

a. directly exchanging signaling of a radio resource control layer for the D2D communication with a user equipment (UE) participating in the D2D communication;

b. implementing locally at the base station a control function of a protocol stack of the radio resource control layer;

wherein the function related to a media access layer for the D2D communication is accomplished by the UE participating the D2D communication.

In the above two aspects of the present invention, since the signaling and protocol stack function of the media access layer for the D2D communication is performed at the UE, which is close to the link of the D2D communication and does not need the participation of the base station, functions of the D2D communication link such as adaptivity, scheduling and HARQ are relatively accurate, effective and low-delay. Since the signaling and protocol stack function of the radio resource control layer is performed at the base station, the base station can maintain its function of controlling the radio resource in a centralized manner in the cell so that the radio resource management in the whole cell is relatively stable and the base station can also perform interference control at system/cell levels. Furthermore, providing the protocol stack function of the radio resource control layer at the base station can prevent the complexity of the UE from being improved.

According to a preferred embodiment, the media access layer and the radio resource control layer are a media access control (MAC) layer and a radio resource control (RRC) layer in long-term evolution respectively. This embodiment provides an application mode of the present invention in the LTE system.

According to another preferred embodiment, the media access layer and the radio resource control layer are a media access control (MAC) layer and a radio resource control and management (RRCM) layer in IEEE 802.16m respectively. This embodiment provides an application mode of the present invention in the IEEE 802.16m.

According to a preferred embodiment, in the radio resource control layer or a lower layer of the radio resource control layer, the 2D2 communication link to which the signaling of the radio resource control layer is related is identified. Since the D2D communication link needs to be distinguished from the cellular link, this embodiment of the present invention identifies the D2D link in the radio resource control layer or a lower layer of the radio resource control layer so that the base station can correctly identify the D2D link and perform corresponding control function.

In a preferred embodiment, the signaling of the media access layer comprises Layer 1 channel state information feedback of the D2D communication link. The Layer 1 channel state information feedback can be used to perform the function of controlling the modulating and coding scheme and link scheduling. Hence, this embodiment can support the function of controlling the modulating and coding scheme and link scheduling of the D2D communication link.

In a preferred embodiment, the signaling of the radio resource control layer comprises a Layer 3 radio resource management measurement report of the D2D communication link. The Layer 3 radio resource management measurement can be used for control functions such as link handover, cell handover and interference management. Hence, this embodiment can support the handover control of the D2D communication link.

In a preferred embodiment, the UE comprises a slave UE in the D2D communication, and the step iii comprises:
sending to the base station a Layer 3 radio resource management measurement report of the D2D communication link;
receiving from the base station a second connection reconfiguration signaling instructing the slave UE to hand over from the D2D communication to a cellular communication with the base station; and

in the step iv, the slave UE performs handover-related protocol stack operations according to the signaling, and directly performs cellular communication with the base station.

In a corresponding embodiment, the UE comprises a master UE in the D2D communication; and the step ii comprises implementing control functions in the protocol stack of the media access layer;

the step iii comprises:
receiving from the base station a first connection reconfiguration signaling instructing the master UE to hand over from the D2D communication to a cellular communication with the base station;
sending a connection reconfiguration completion signaling to the base station; and

the master UE performs handover-related protocol stack operations according to the first connection reconfiguration signaling, and directly establishes the cellular communication with the base station.

In another corresponding embodiment, the step a comprises the following steps:
receiving a Layer 3 radio resource management measurement report which is sent by the slave UE in the D2D communication and is related to the D2D communication link;

the step b comprises determining, according to the measurement report, whether to hand over from the D2D communication to the cellular communication between the slave UE and the base station;

and upon determining to hand over,

the step a further comprises the following steps:
sending a first connection reconfiguration signaling to the master UE in the D2D communication, the first connection reconfiguration signaling instructing the master UE to hand over from the D2D communication to the cellular communication;
receiving a connection reconfiguration completion signaling from the master UE;
sending a second connection reconfiguration signaling to the slave UE, the second connection reconfiguration signaling instructing the slave UE to hand over from the D2D communication to the cellular communication between the slave UE and the base station; and

the base station directly performs cellular communication with the slave UE and the master UE respectively.

The above three embodiments describe operations to be performed by respective network elements when handing over from the D2D communication link to the cellular communication, and provide a function of handing over from the D2D communication to the ordinary cellular communication.

In order to solve data asynchronization problem when handing over from the D2D communication to the cellular communication, handover-related operations performed by the master UE include:
sending information for traffic data synchronization to the base station, including uplink packets receiving status and downlink packets transmitting status;
forwarding uplink/downlink traffic data to the base station.

In the base station, the method further comprises the following steps:
receiving information used for traffic data synchronization from the master UE, including uplink packets receiving status, downlink packets transmitting status, and the uplink/downlink traffic data themselves;
synchronizing the cellular communication with the D2D communication before handover based on the information for the traffic data synchronization, so as to achieve sequential packet-lossless traffic data transmission.

This embodiment achieves sequential packet-lossless seamless hand over from the D2D communication to the cellular communication.

In a preferred embodiment, in the UE, the method further comprises the following steps:

x. directly exchanging with another UE signaling of a PDCP layer and an RLC layer for the D2D communication;

y. performing locally at the UE protocol stack function of the PDCP layer and the RLC layer for the D2D communication.

In this embodiment, there is provided a mode of deploying the packet data convergence protocol (PDCP) layer and radio link control (RLC) layer in the D2D communication.

### BRIEF DESCRIPTION OF DRAWINGS

Other features, objects and advantages of the present invention will be made more apparent by reading through detailed description of the non-restrictive embodiments with reference to the following figures:

FIG. 1 illustrates one example of D2D communication scenario;

FIG. 2 illustrates a schematic view of a control plane in an LTE system;

FIG. 3 illustrates a schematic view of division of control functions of the control plane between a base station and a D2D master UE according to an embodiment of the present invention under the D2D scenario;

FIG. 4 illustrates a schematic view of protocol stack exchanges between the master UE and a slave UE according to an embodiment of the present invention under the D2D scenario;

FIG. 5 illustrates a schematic view of protocol stack exchanges between the master/slave UE and the base station according to an embodiment of the present invention under the D2D scenario;

FIG. 6 illustrates a schematic view of channel measurement report exchanges of Layer 1 and Layer 3 between the master/slave UE and the base station according to an embodiment of the present invention under D2D scenario;

FIG. 7 illustrates a schematic view of handover of the radio network as shown in FIG. 6 from D2D communication to cellular communication;

FIG. 8 illustrates signaling and data exchanges during the handover from D2D communication to the cellular communication as shown in FIG. 7.

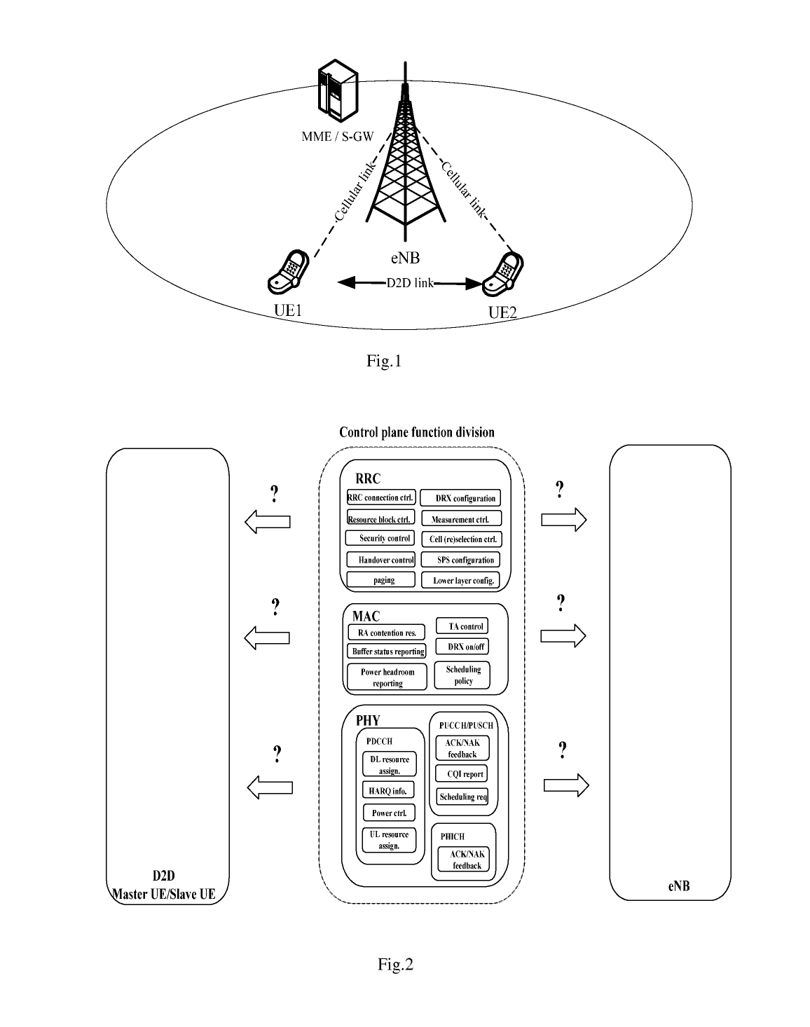

### DETAILED DESCRIPTION OF PREFERRED EMBODIMENTS

The present invention provides a method of performing device-to-device (D2D) communication in a user equipment (UE), wherein the method comprises the following steps:

i. directly exchanging with another UE signaling of a media access layer for the D2D communication;

ii. implementing locally at the UE protocol stack function of the media access layer for the D2D communication;

and steps of:

iii. directly exchanging with a base station signaling of a radio resource control layer for the D2D communication;

iv. implementing locally at the UE protocol stack function of the radio resource control layer for the D2D communication.

The present invention provides a method of controlling device-to-device (D2D) communication in a base station, wherein the method comprises the following steps:

a. directly exchanging signaling of a radio resource control layer for the D2D communication with a user equipment (UE) participating in the D2D communication;

b. implementing locally at the base station a control function of a protocol stack of the radio resource control layer;

wherein the function related to a media access layer for the D2D communication is accomplished by the UE participating the D2D communication.

In an LTE/SAE (system architecture evolution) network, the media access layer and the radio resource control layer are the media access control (MAC) layer and the radio resource control (RRC) layer respectively. Similarly, in IEEE 802.16m network, the media access layer and the radio resource control layer are the media access control (MAC) layer and the radio resource control and management (RRCM) layer respectively. Although the following embodiments of the present invention are described with the LTE network as an example, it may be appreciated that they also apply to the IEEE 802.16m network.

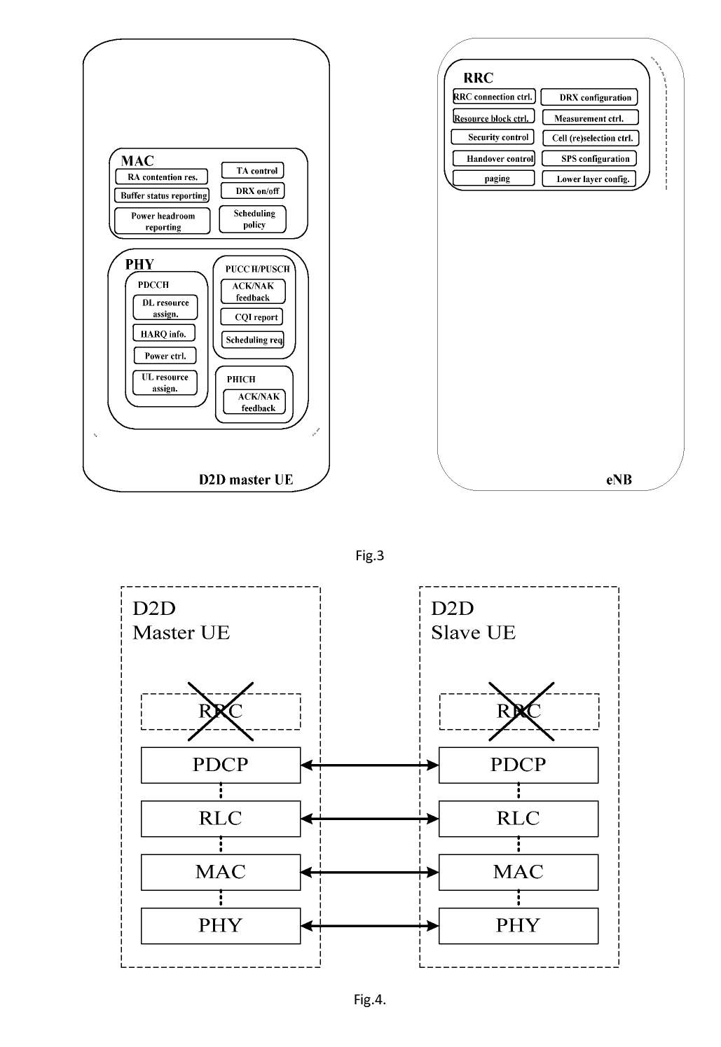

In the LTE system, the protocol stack of the media access control layer is deployed in the UE performing communication, whereas the protocol stack of the radio resource management layer is deployed in the UE and the base station. FIG. 3 illustrates main control functions of the MAC layer and the RRC layer, which are respectively located in the master UE of the D2D communication and the base station. The slave UE in the D2D communication is also provided with protocol stacks of the MAC layer and the RRC layer, wherein the MAC layer directly communicates with the MAC layer protocol stack of the master UE, whereas the RRC layer directly communicates with the RRC layer protocol stack of the base station.

As shown in FIG. 3, the RRC layer protocol stack of the base station performs all RRC-related control functions for the D2D communication, including RRC connection control, bearer control, DRX configuration, lower layer configuration etc. In the master UE, the MAC layer protocol stack performs all MAC-related control functions for the D2D communication, including BSR (buffer status reporting), TA control, scheduling/transport format selection etc. It may be appreciated that the control functions of the RRC layer as listed here are only exemplary, and any functions belonging to connection management in functionality should fall within the category of the RRC layer protocol function; similarly, the control functions of the MAC layer as listed here are only exemplary, and any functions belonging to link adaptivity/scheduling in functionality should fall within the category of the MAC layer protocol function.

FIG. 4 illustrates a manner of configuring protocol stack between the master UE and slave UE in the D2D communication, as well as a signaling exchanging manner. As shown in FIG. 4, the master UE and the slave UE directly exchange MAC layer signaling via a radio link therebetween as shown by a solid arrow between MAC layers in the figure. It may be appreciated that direct interaction between two layers as stated here is logical, and physically the signaling of the two layers still needs to be provided to a lower layer (as shown in the dotted line between layers in the figure) and is actually transmitted on a physical air interface after being subjected to a lower layer packetizing.

According to a further embodiment of the present invention, the master UE and the slave UE further exchange PDCP (packet data convergence protocol) layer and an RLC (radio link control) layer signaling for the D2D communication, as shown in the solid arrow between PDCP layers and the solid arrow between RLC layers in FIG. 4. The PDCP layer functions to encrypt/decrypt and the RLC layer functions the same as in the user plane. It may be appreciated that the direct interaction as stated here is logical, and physically the signaling of the two layers still needs to be provided to a lower layer (as shown in the dotted line between layers in the figure) and is actually transmitted on a physical air interface after being subjected to lower layer packetizing. Furthermore, the master UE and the slave UE also locally perform the protocol stack function of the PDCP layer and the RLC layer for the D2D communication. Specific protocol stack functions of the PDCP layer and the RLC layer are well known in the art and will not be detailed here.

FIG. 5 illustrates a manner of configuring protocol stack between the master/slave UE and the base station in the D2D communication, as well as a signaling exchanging manner. As shown in FIG. 5, the master/slave UE and the base station directly exchange the RRC layer signaling via a radio link therebetween, as shown by a solid arrow between RRC layers in the figure. It may be appreciated that direct interaction between two layers as stated here is logical, and physically the signaling of the two layers still needs to be provided to a lower layer (as shown in the dotted line between layers in the figure) and is actually transmitted on a physical air interface after being subjected to lower layer packetizing. As shown in FIG. 5, the RRC layer signaling of the UE is still packetized by its MAC layer as MAC PDU, and then is sent by the PHY physical layer to the base station, and the base station de-packetizes it into MAC SDU by the MAC layer and sends it to the RRC layer.

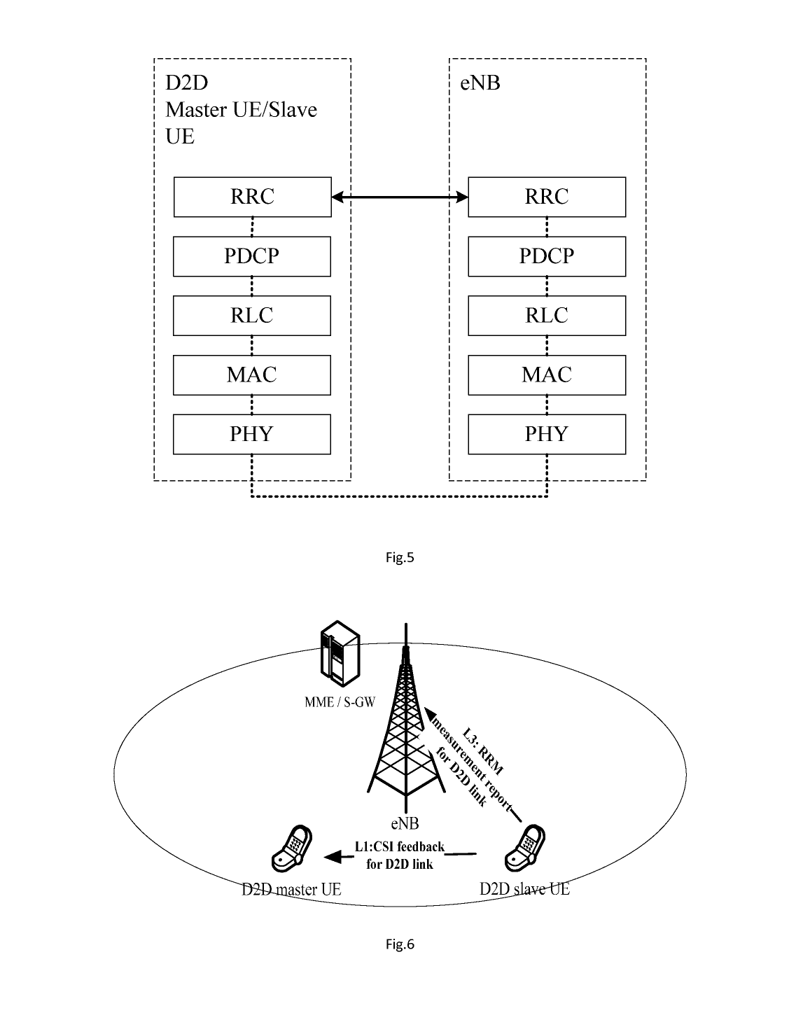

After the division of the control plane according to the present invention is described, the signaling exchanging according to the present invention will be described with reference to a network topology structure as shown in FIG. 6.

Regarding the MAC layer function for the D2D communication, the control function is configured at the master UE. Hence, the Layer 1 channel state indication of the D2D link is sent by the slave UE to the master UE. Regarding the RRC layer function for the D2D communication, the control function is configured at the base station, so Layer 3 radio resource management measurement report of the D2D link is directly sent by the slave UE to the base station, and the base station controls whether the slave UE hands over from the D2D communication to the cellular communication according to the report. The whole handover procedure will be described in detail hereunder.

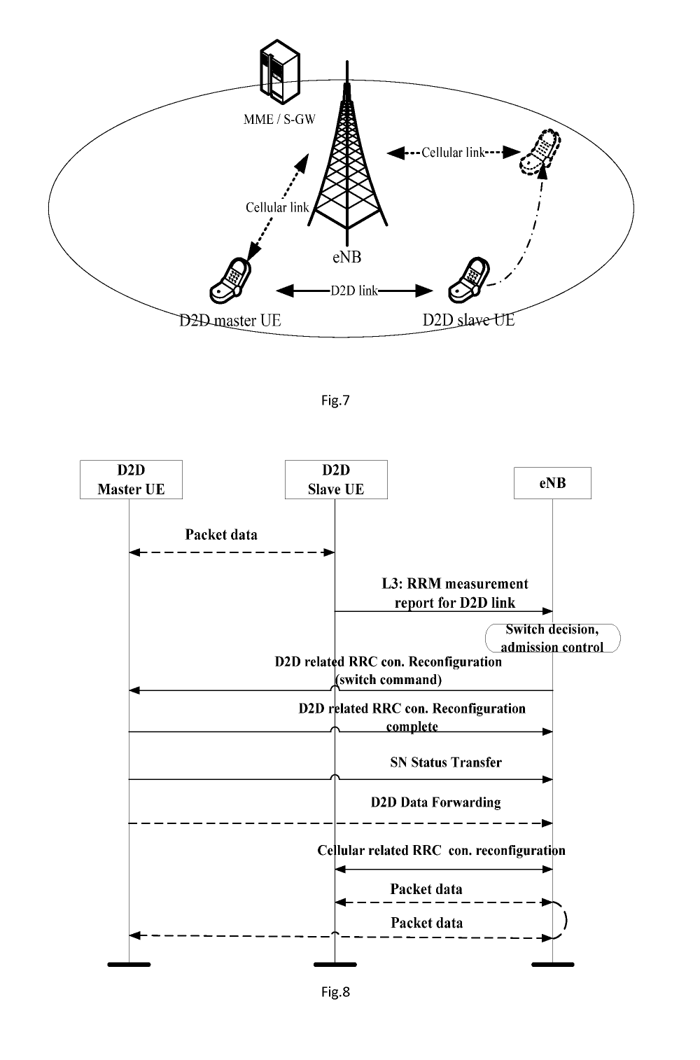

As shown in FIG. 7 and FIG. 8, the slave UE performs D2D communication with the master UE via the D2D link. Furthermore, the slave UE is moving, and it has already moved to a position away from the master UE as shown by the dotted line in the figure.

The slave UE performs measurement on the communication condition of the D2D link, and directly sends the Layer 3 radio resource management (RRM) measurement report of the D2D link to the base station. As the slave UE is far away from the master UE, the RRM report can reflect this condition. It may be appreciated that the UE identifies the D2D link to which this RRM report is related, in the RRC layer or a lower layer of the RCC layer, such as the MAC layer. Correspondingly, the base station also identifies the D2D link in a lower layer of the RRC layer or the RRC layer.

Thereafter, the control function of the RRC layer protocol stack of the base station determines that the D2D link has already been degraded to be useless, so the base station decides to hand over the D2D communication to the cellular communication between the slave UE and the base station. The base station performs access control for the slave UE, and then determines that the slave UE is permitted to directly access the base station.

Then, the base station sends D2D link-related RRC connection reconfiguration signaling to the master UE in the D2D communication, the signaling instructing the master UE to hand over from the D2D communication to the cellular communication.

The master UE sends a connection reconfiguration completion signaling to the base station, performs handover-related protocol stack operations according to the first connection reconfiguration signaling, and establishes cellular communication directly with the base station, as shown in FIG. 7 and FIG. 8.

Furthermore, the base station further sends the connection reconfiguration signaling for the cellular communication to the slave UE, the signaling instructing the slave UE to hand over from the D2D communication to the cellular communication between the slave UE and the base station.

The slave UE performs handover-related protocol stack operations according to the connection reconfiguration signaling for the cellular communication, and directly performs cellular communication with the base station, as shown in FIG. 7 and FIG. 8.

Preferably, in order to achieve seamless handover without data loss, the master UE sends information for traffic data synchronization to the base station. The information is for example SN STATUS TRANSFER message, which includes uplink packets receiver status and downlink packets transmitter status, and the master UE transfers the uplink/downlink traffic data to the base station. Correspondingly, the base station receives information used for traffic data synchronization from the master UE, as well as the uplink/downlink traffic data themselves, and synchronizes the cellular communication with the D2D communication before the handover based on the information used for traffic data synchronization, so as to achieve sequential packet-lossless traffic data transmission.

It is appreciated that in absence of conflict, embodiments of the present application and features in embodiments may be combined arbitrarily.

Certainly, the present invention may include other various embodiments. Without departure from the spirit and essence of the present invention, those skilled in the art may make diverse corresponding changes and variations according to the present invention, and these corresponding changes and variations all should fall within the protection scope defined as the appended claims.

Those skilled in the art may understand that all or partial steps of the above method may be accomplished by a program instructing related hardware. The program may be stored in a computer-readable storage medium such as read-only memory, magnetic disk or optical disc. Alternatively, all or partial steps of the above embodiments may be implemented by using one or more integrated circuits. Correspondingly, all modules/units in the above embodiments may be implemented by using either hardware or software functional modules. The present invention is not limited to any particular combinations of hardware and software.

1. A method of performing device-to-device (D2D) communication in a user equipment (UE), wherein the method comprises:
directly exchanging with another UE signaling of a media access layer for the D2D communication;
implementing locally at the UE protocol stack function of the media access layer for the D2D communication;
and:
directly exchanging with a base station signaling of a radio resource control layer for the D2D communication;
implementing locally at the UE protocol stack function of the radio resource control layer for the D2D communication.

2. The method according to claim 1, wherein, the media access layer and the radio resource control layer are a media access control layer and a radio resource control layer in long-term evolution, respectively; or
the media access layer and the radio resource control layer are a media access control layer and a radio resource control and management (RRCM) layer in IEEE 802.16m, respectively.

3. The method according to claim 1, wherein, in the directly exchanging with a base station signaling of a radio resource control layer for the D2D communication, in the radio resource control layer or a lower layer of the radio resource control layer, a D2D communication link to which the signaling of the radio resource control layer is related is identified.

4. The method according to claim 1, wherein, in the directly exchanging with another UE signaling of a media access layer for the D2D communication, the signaling of the media access layer comprises Layer 1 channel state information feedback of a D2D communication link;
and/or,
in the directly exchanging with a base station signaling of a radio resource control layer for the D2D communication, the signaling of the radio resource control layer comprises a Layer 3 radio resource management measurement report of the D2D communication link.

5. The method according to claim 1, wherein, the UE comprises a slave UE in a D2D communication, and the directly exchanging with a base station signaling of a radio resource control layer for the D2D communication comprises:
sending to the base station a Layer 3 radio resource management measurement report of the D2D communication link;
receiving from the base station a second connection reconfiguration signaling instructing the slave UE to hand over from the D2D communication to a cellular communication with the base station; and
in the implementing locally at the UE protocol stack function of the radio resource control layer for the D2D communication step iv, the slave UE performs handover-related protocol stack operations according to the signaling, and directly performs cellular communication with the base station.

6. The method according to claim 1, wherein, the UE comprises a master UE in the D2D communication; and the implementing locally at the UE protocol stack function of the media access layer for the D2D communication comprises implementing control functions in the protocol stack of the media access layer;
the directly exchanging with a base station signaling of a radio resource control layer for the D2D communication comprises:
receiving from the base station a first connection reconfiguration signaling instructing the master UE to hand over from the D2D communication to a cellular communication with the base station;
sending a connection reconfiguration completion signaling to the base station; and
the master UE performs handover-related protocol stack operations according to the first connection reconfiguration signaling, and directly establishes the cellular communication with the base station.

7. The method according to claim 6, wherein, the handover-related operations performed by the master UE include:
sending information for traffic data synchronization to the base station, including uplink packets receiving status and downlink packets transmitting status;
forwarding uplink/downlink traffic data to the base station.

8. The method according to claim 1, wherein, the method further comprises:
directly exchanging with another UE signaling of a PDCP layer and an RLC layer for the D2D communication;
performing locally at the UE protocol stack function of the PDCP layer and the RLC layer for the D2D communication.

9. A method of controlling device-to-device (D2D) communication in a base station, wherein the method comprises:
directly exchanging signaling of a radio resource control layer for the D2D communication with a user equipment (UE) participating in the D2D communication;
implementing locally at the base station a control function of a protocol stack of the radio resource control layer;
wherein function related to a media access layer for the D2D communication is accomplished by the UE participating the D2D communication.

10. The method according to claim 9, wherein, the radio resource control layer comprises:
a radio resource control layer in long-term evolution;
a radio resource control and management layer in IEEE 802.16m.

11. The method according to claim 9, wherein, in the directly exchanging signaling of a radio resource control layer for the D2D communication with a user equipment (UE) participating in the D2D communication, in the radio resource control layer or a lower layer of the radio resource control layer, a D2D communication link to which the signaling of the radio resource control layer is related is identified.

12. The method according to claim 9, characterized in that, in the directly exchanging signaling of a radio resource control layer for the D2D communication with a user equipment (UE) participating in the D2D communication, the signaling of the radio resource control layer comprises a Layer 3 radio resource management measurement report of a D2D communication link.

13. The method according to claim 9, wherein the directly exchanging signaling of a radio resource control layer for the D2D communication with a user equipment (UE) participating in the D2D communication comprises:
receiving a Layer 3 radio resource management measurement report which is sent by the slave UE in the D2D communication and is related to a D2D communication link;
the implementing locally at the base station a control function of a protocol stack of the radio resource control layer comprises determining, according to the measurement report, whether to hand over from the D2D communication to the cellular communication between the slave UE and the base station;
and upon determining to hand over,
the directly exchanging signaling of a radio resource control layer for the D2D communication with a user equipment (UE) participating in the D2D communication further comprises:
sending a first connection reconfiguration signaling to the master UE in the D2D communication, the first connection reconfiguration signaling instructing the master UE to hand over from the D2D communication to the cellular communication;
receiving a connection reconfiguration completion signaling from the master UE;
sending a second connection reconfiguration signaling to the slave UE, the second connection reconfiguration signaling instructing the slave UE to hand over from the D2D communication to the cellular communication between the slave UE and the base station; and
the base station directly performs cellular communication with the slave UE and the master UE respectively.

14. The method according to claim 13, wherein, the method further comprises:
receiving information used for traffic data synchronization from the master UE, including uplink packets receiving status, downlink packets transmitting status, and uplink/downlink traffic data themselves;
synchronizing the cellular communication with the D2D communication before the handover based on the information used for the traffic data synchronization, so as to achieve sequential packet-lossless traffic data transmission.
